(19) United States
(12) Patent Application Publication
(10) Pub. No.: US 2023/0270150 A1
(43) Pub. Date: Aug. 31, 2023

(54) A Low Cost Biodegradable Drinking Straw

(71) Applicants: Yongzhong Zhang, Irvine, CA (US); Junhua Wang, Nanchang City (CN); Gang Chen, Nanchang City (CN)

(72) Inventors: Yongzhong Zhang, Irvine, CA (US); Junhua Wang, Nanchang City (CN); Gang Chen, Nanchang City (CN)

(21) Appl. No.: 17/918,062

(22) PCT Filed: Nov. 3, 2020
(86) PCT No.: PCT/US2020/058705

§ 371 Date: Oct. 10, 2022

(51) Int. Cl. A23L 29/212; A47G 21/18; A23P 30/20; A23L 29/00; A23L 29/244; A23L 29/256; A23L 29/238; A23L 29/269

(52) U.S. Cl. CPC A23L 29/212; A23L 29/06; A23L 29/238; A23L 29/244; A23L 29/256; A23L 29/27; A23L 29/272; A23P 30/20; A47G 21/18

(57) ABSTRACT

A low cost biodegradable drinking straw comprising structurally non-altered corn starch mixed with one or more than one improver. The improver comprises a biological enzyme preparation and a colloid preparation. The low cost biodegradable drinking straw is made by providing 98% structurally non-altered corn starch mixed with one or more than one improver to make a biodegradable powder. The edible biodegradable powder is formed into a drinking straw shape and extruded to a drinking straw shape. When the extruded drinking straw shapes are cooled, they are cut into an appropriate drinking straw length. The cut drinking straws are then dried and packaged.

### CROSS-REFERENCE TO RELATED APPLICATIONS

This Application is a national stage filing of Patent Application No. WO PCT/US2020/058705, filed on 2020-11-03, the contents of which are incorporated herein by reference in their entirety.

### FIELD OF THE INVENTION

The present invention is in the technical field of drinking straws and more particularly to a safe, convenient, hygienic, biodegradable, environmental safe, low-cost drinking straw.

### BACKGROUND

It is estimated that in the United States alone, 500 million plastic straws are used every single day. Most of these plastic straws will end up in the oceans, polluting the water and killing marine life. Also, most plastic straws are too lightweight to make it through mechanical recycling sorters. The plastic straws drop through sorting screens and mix with other materials and are too small to separate, contaminating recycling loads or getting disposed as garbage.

When plastic straws do make it into the ocean it breaks down into smaller and smaller pieces known as “microplastics” rather than biodegrading or dissolving, which poses great threats to marine life including fish.

One alternative has been compostable plastic straws. While compostable plastic straws are good in theory, they are mostly disposed of incorrectly and end up in the water ways just like regular plastic straws. Also, compostable plastic straws are no better than regular plastic straws when they get into the oceans. Compostable plastic straws are designed to break down in compost facility conditions, not sea water.

Another, older alternative is paper drinking straws. However, most consumers dislike paper drinking straws as they quickly collapse and do not hold up when immersed in liquid for any length of time. This leads to frustration by the user and multiple paper drinking straws being used. Although better than either plastic or compostable drinking straws, the manufacture of paper straws is more expensive and not as resilient as the above alternatives.

Other alternatives include polyethylene coated paperboard, pulp molding, plant straw, shell molding, degradable plastics, starch biodegradation and other tableware materials or products, but they almost ignore one another and cannot meet the advantages of safety, hygiene, convenience, environmental protection and low cost at the same time. For example:

US20180282509A1 describes biodegradable bioplastic compositions and method of making and using the same.

CA2114157A1 describes a method of producing container products by means of the synthesis of cereal straws or shells, starch, and degradable materials.

CN110684240A relates to a preparation method of degradable edible multi-flavor tableware.

CN110041568A describes an edible environmental protection straw and its preparation method.

At present, in order to improve the heat-resistant and soaking resistant function of the prior art straws and trying to realize some commercial value, prior art technologies use rice starch as the main raw material. Other technologies use modified starch by processing the starch to change its molecular structure, and using that resultant as the main raw material. Another technology adds some plastic raw materials to the starch improver to enhance the performance of heat-resistant and soaking resistant straw.

Therefore, there is a need for a safe, convenient, hygienic, biodegradable, environmental safe, low-cost drinking straw, overcoming the limitations of the prior art.

### BRIEF DESCRIPTION OF THE DRAWINGS

These and other features, aspects and advantages of the present invention will become better understood with regard to the following description, appended claims, and accompanying figures where:

FIG. 1 is a flowchart diagram of some steps of a method for producing a safe, convenient, hygienic, biodegradable, environmental safe, low-cost drinking straw; and

FIG. 2 is an example of a safe, convenient, hygienic, biodegradable, environmental safe, low-cost drinking straw, according to one embodiment of the present invention.

### SUMMARY

The present invention overcomes the limitations of the prior are by using a method for making a low cost biodegradable drinking straw. First, structurally non-altered corn starch is provided and mixed with one or more than one improver to make a biodegradable powder. Then, the edible biodegradable powder is extruded into a drinking straw shape and cooled. Next, the cooled drinking straw shaped extrusion is cut into appropriate drinking straw lengths and dried. Finally, the dried drinking straws are packaged for use.

The structurally non-altered corn starch comprises 90-98% of the drinking straw, and preferably the drinking straw comprises 98% structurally non-altered corn starch. The drinking straw comprises 2%-8% of one or more than one starch improver, wherein the one or more than one starch improver comprises a biological enzyme component and an edible colloid component.

The one or more than one biological enzyme component comprises a combination of 1%-5% of a-amylase, 1%-5% of glucose oxidase, 1%-5% of protease, and 1%-5% of xylanase. Preferably, the one or more than one biological enzyme component comprises 2% of a-amylase, 3% of glucose oxidase and 3% of protease.

The one or more than one colloid component comprises one or more than one colloid component that has one or more than one of: 1%-35% konjac gum, 1%-35% agar, 1%-35% carrageenan, 1%-35% sodium alginate, 1%-35% guar gum, 1%-35% gellan gum, and 1%-45% xanthan gum. Preferably, the one or more than one colloid component comprises 21% of konjac gum, 29% of sodium alginate, 32% of xanthan gum and 10% of gellan gum

There is also provided a low cost biodegradable edible drinking straw made of structurally non-altered corn starch and one or more than one starch improver, wherein the improver comprises a biological enzyme preparations and an edible colloid preparations. The biodegradable edible drinking straw comprises 90% -98% corn starch and 2%-8% starch improver. Preferably, the biodegradable edible drinking straw comprises 98% corn starch and 2% starch improver. The one or more than one biological enzyme preparations comprises one or more than one of a -amylase, glucose oxidase, protease, xylanase, konjac gum, sodium alginate, xanthan gum and gellan gum. Preferably, the one or more than one biological enzyme preparations comprises 2% a- amylase, 3% of glucose oxidase and 3% of protease. The biodegradable edible drinking straw, wherein the one or more than one edible colloid preparations comprises one or more than one of konjac gum, agar, carrageenan, sodium alginate, guar gum, gellan gum, and xanthan gum. Preferably, the one or more than one edible colloid preparations comprises 25% of konjac gum, 25% sodium alginate, 35% xanthan gum, and 15% gellan gum. The biological enzyme preparations are food grade enzyme preparations and, wherein the edible colloid prepartations are high integrity food grade colloids.

### DETAILED DESCRIPTION OF THE INVENTION

The present invention overcomes the limitations of the prior art by providing a safe, convenient, hygienic, biodegradable, environmental safe, low-cost drinking straw.

This invention uses corn starch as raw material, and a small amount of starch improver, comprising a variety of biological enzyme preparation and colloid, that are added to the corn starch to make a biodegradable straw, solving the problem of high cost of raw material and environmental pollution. The straws can be soaked in normal temperature water (25° C.) for 1-1.5 hours without breaking. The straws can be soaked in warm water at 40° C. for 0.5-1 hours without breaking. The straws can be soaked in acidic drinks (pH: 5.0-7.0) at normal temperature (25° C.) for 0.5-1 hours without breaking. The straws can be soaked in alkaline drinks (pH: 7.0-9.0) at normal temperature (25° C.) for 0.5-1 hours without breaking and still be used as a straw.

This present invention improves the prior art by creating a corn starch by enzyme preparation and edible colloid, enhancing the heat-resistant and soaking resistant of the straw to realize its commercial value.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and processes according to various embodiments disclosed. In this regard, each block in the flowchart or block diagrams can represent a step in the process. It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged.

In the following description, certain terminology is used to describe certain features of one or more embodiments of the invention.

The term “improver” refers to a variety of biological enzyme preparations and colloids.

Various embodiments provide a low cost biodegradable drinking straw. One embodiment of the present invention provides a low cost biodegradable drinking straw. In another embodiment, there is provided a method for using the straw. The method and use will now be disclosed in detail.

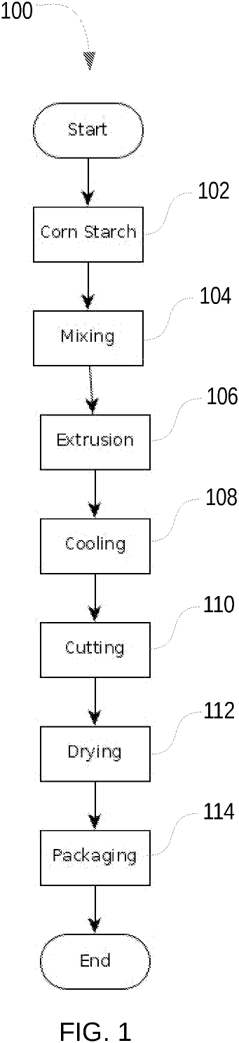

Referring now to FIG. 1, there is shown a flowchart diagram of some steps of a method for producing a safe, convenient, hygienic, biodegradable, environmental safe, low-cost drinking straw. First, structurally non-altered corn starch 102 is provided to make the straw. Then, the structurally non-altered corn starch is mixed 104 with one or more than one improver. Next, the mixture is extruded 106 into a straw shape. Then, the straw shaped extrusion is cooled 108. Next, the cooled straw shaped extrusion is cut 110 to an appropriate length. Then, the cut straws are dried 112. Finally, the dried straws are placed into packages 114.

Advantageously, using corn starch as the raw material provides a convenient, low price, highly available source, for mass production in the future, with low price and rich sources. Also, producing these biodegradable straws using corn starch instead of rice starch will not compete with humans for food, which solves the problem of popularization and application of this invention.

Unlike the current art, the present invention uses non-altered corn starch as the main raw material, adding amylase, glucose oxidase, xylanase, sodium alginate, konjac gum and other biological enzyme preparations and colloids, and then mixing, extruding, cooling, cutting, drying and molding, to produce heat-resistant and soaking resistant straw. Most current applications take corn starch and combine it with rice starch and cassava starch.

Also unlike the current art, the present invention does not contain non degradable plastic components which would defeat the biodegradable aspect that other inventions do not have.

The starch improvers comprise biological enzyme preparation and edible colloids, without adding plastic components or other chemical reagents, which is safe and reliable. The degradable straw produced has a soaking resistance and a temperature resistance, that can replace the current food grade straws. The degradable straws readily degrade and do not pollute the environment as all components of the straw are organic. The degradable straws can also be used as raw materials for animal feed after treatment.

In one aspect of the present invention, the improver comprises a variety of biological enzyme preparations and colloids. Then the corn starch and the improver are mixed together. After being thoroughly mixed, the biodegradable powder is extruded into a straw like shape. At present, the raw material of currently available degradable straws is mainly rice starch, without adding or adding a small amount of corn starch.

### Option 1

In a preferred embodiment of the invention the biological enzyme preparations and edible colloids comprise: a -amylase, glucose oxidase, konjac gum, sodium alginate and xanthan gum. More specifically, the Biological enzyme preparations are comprise 5% of a-amylase and 2% of glucose oxidase. The colloids comprise 23% of konjac gum, 38% of sodium alginate, and 32% of xanthan gum. The mixture uses 2% -10% of a-amylase, mixed with 1%-5% of glucose oxidase, mixed with 20-35% of konjac gum, mixed with 35%-45% of sodium alginate, mixed with 30%-40% of xanthan gum.

To prepare the biodegradable powder for extrusion, the mixture comprises 98% non-altered corn starch. The remaining 2% is a mixture of 2%-10% of a-amylase. 1%-5% of glucose oxidase, 1%-5% of protease, 15%-25% of konjac gum, 30%-40% of sodium alginate, and 35%-45% of xanthan gum. Where, the a -amylase, glucose oxidase and protease are food grade enzyme preparations, that are widely used in the production of bread and cake. Konjac gum, sodium alginate and xanthan gum are food grade edible colloids, that can be used as food additives with high integrity.

### Option 2

In another embodiment, the biological enzyme preparations and colloids comprise a -amylase, glucose oxidase, protease, konjac gum, sodium alginate and xanthan gum. More specifically, the biological enzyme preparations comprise of 3% of a-amylase, 2% of glucose oxidase and 2% of protease. The edible colloids comprise 18% of konjac gum, 34% of sodium alginate, and 41% of xanthan gum.

### Option 3

In another embodiment, the biological enzyme preparations comprise a -amylase, glucose oxidase, protease,konjac gum, sodium alginate, xanthan gum and gellan gum.

More specifically, the biological enzyme preparations comprise 2% of a-amylase,3% of glucose oxidase and 3% of protease. The colloids comprise 21% of konjac gum, 29% of sodium alginate, 32% of xanthan gum and 10% of gellan gum.

To prepare the biodegradable powder for extrusion, the mixture comprises 98% non-altered corn starch. The remaining 2% is a mixture of 2% -8% of a-amylase, mixed with 1%-5% of glucose oxidase, mixed with 1%-5% of protease, mixed with 15%-25% of konjac gum, mixed with 25-35% of sodium alginate, mixed with 30%-40% of xanthan gum,mixed with 5%-15% of gellan gum.

### Option 4

In another embodiment, the biological enzyme preparations comprise a -amylase, glucose oxidase, protease, xylanase, konjac gum, sodium alginate, xanthan gum and gellan gum.

More specifically, the biological enzyme preparations comprise 2% of a-amylase, 3% of glucose oxidase and 3% of protease. The colloids comprise 21% of konjac gum, 29% of sodium alginate, 32% of xanthan gum and 10% of gellan gum.

To prepare the biodegradable powder for extrusion, the mixture comprises 98% non-altered corn starch. The remaining 2% is a mixture of 2%-8% of a-amylase, mixed with 1%-5% of glucose oxidase, mixed with 1%-5% of protease, mixed with 15%-25% of konjac gum, mixed with 25%-35% of sodium alginate, mixed with 30%-40% of xanthan gum,mixed with 5%-15% of gellan gum.

### Option 5

In another embodiment, the biological enzyme preparations comprise a -amylase, glucose oxidase, xylanase, konjac gum, sodium alginate, xanthan gum and gellan gum.

More specifically, the biological enzyme preparations comprise 2% of a-amylase, 3% of glucose oxidase and 3% of xylanase. The colloids comprise 21% of konjac gum, 29% of sodium alginate, 32% of xanthan gum and 10% of gellan gum.

To prepare the biodegradable powder for extrusion, the mixture comprises 98% non-altered corn starch. The remaining 2% is a mixture of 2% -8% of a-amylase, mixed with 1-5% of glucose oxidase, mixed with 1%-5% of xylanase, mixed with 15%-25% of konjac gum, mixed with 25%-35% of sodium alginate, mixed with 30%-40% of xanthan gum,mixed with 5%-15% of gellan gum.

### Option 6

In another embodiment, the biological enzyme preparations comprise a -amylase, glucose oxidase, xylanase, konjac gum, sodium alginate, xanthan gum and agar.

More specifically, the biological enzyme preparations comprise 2% of a-amylase, 4% of glucose oxidase and 2% of xylanase. The colloids comprise 21% of konjac gum, 29% of sodium alginate, 32% of xanthan gum and 10% of agar.

To prepare the biodegradable powder for extrusion, the mixture comprises 98% non-altered corn starch. The remaining 2% is a mixture of 2% -8% of a-amylase, mixed with 1-5% of glucose oxidase, mixed with 1%-5% of xylanase, mixed with 15%-25% of konjac gum, mixed with 25%-35% of sodium alginate, mixed with 30-40% of xanthan gum,mixed with 5%-15% of agar.

### Option 7

In another embodiment, the biological enzyme preparations comprise a -amylase, glucose oxidase, xylanase, konjac gum, sodium alginate, xanthan gum and carrageenan.

More specifically, the biological enzyme preparations comprise 3% of a-amylase, 3% of glucose oxidase and 2% of xylanase. The colloids comprise 25% of konjac gum, 25% of sodium alginate, 32% of xanthan gum and 10% of carrageenan.

To prepare the biodegradable powder for extrusion, the mixture comprises 98% non-altered corn starch. The remaining 2% is a mixture of 2% -8% of a-amylase, mixed with 1%-5% of glucose oxidase, mixed with 1%-5% of xylanase, mixed with 20%-30% of konjac gum, mixed with 20%-30% of sodium alginate, mixed with 30%-40% of xanthan gum,mixed with 5%-15% of carrageenan.

### Option 8

In another embodiment, the biological enzyme preparations comprise a -amylase, glucose oxidase, xylanase, konjac gum, sodium alginate, xanthan gum and guar gum.

More specifically, the biological enzyme preparations comprise 3% of a-amylase, 3% of glucose oxidase and 2% of xylanase. The colloids comprise 24% of konjac gum, 28% of sodium alginate, 32% of xanthan gum and 8% of guar gum.

To prepare the biodegradable powder for extrusion, the mixture comprises 98% non-altered corn starch. The remaining 2% is a mixture of 2% -8% of a-amylase, mixed with 1%-5% of glucose oxidase, mixed with 1%-5% of xylanase, mixed with 20%-30% of konjac gum, mixed with 20%-30% of sodium alginate, mixed with 30%-40% of xanthan gum, mixed with 5%-15% of guar gum.

In the preferred embodiment, the characteristics of the biodegradable straws made from this formulation and method are as follows:
1) the straws can be soaked in normal temperature water (25° C.) for 1-1.5 hours without breaking;
2) the straws can be soaked in warm water at 40° C. for 0.5-1 hours without breaking;
3) the straws can be soaked in acidic drinks(pH: 5.0-7.0) at normal temperature (25° C.) for 0.5-1 hours without breaking;
4) the straws can be soaked in alkaline drinks (pH: 7.0-9.0) at normal temperature(25° C.) for 0.5-1 hours without breaking;
5) the straws still function as a drinking straw while in any of the above conditions.

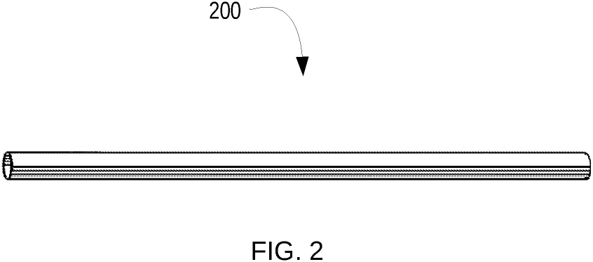

Referring now to FIG. 2, there is shown a safe, convenient, hygienic, biodegradable, environmental safe, low-cost drinking straw 200, according to one embodiment of the present invention. The drinking straw 200 comprises 98% corn starch as raw material, and a small amount of starch improver, comprising a variety of biological enzyme preparation and colloid, that are added to the corn starch to make a biodegradable straw, solving the problem of high cost of raw material and environmental pollution.

The main raw material for producing the biodegradable drinking straw 200 is corn starch, which does not contain rice starch and/or plastic raw materials. Additionally, producing biodegradable drinking straw 200 with corn starch greatly reduces cost.

The drinking straw 200 can be soaked in normal temperature water (25° C.) for 1-1.5 hours without breaking. The drinking straw 200 can be soaked in warm water at 40° C. for 0.5-1 hours without breaking. The drinking straw 200 can be soaked in acidic drinks (pH: 5.0-7.0) at normal temperature (25° C.) for 0.5-1 hours without breaking. The drinking straw 200 can be soaked in alkaline drinks (pH: 7.0-9.0) at normal temperature (25° C.) for 0.5-1 hours without breaking and still be used as a straw.

Experimental results prove that the drinking straw 200 is feasible and can be realized. The drinking straw 200 uses 90%-98% corn starch and 2%-8% starch improver, comprising a variety of biological enzyme preparations and colloids, to make the biodegradable drinking straw 200. The drinking straw 200 were soaked in normal temperature water (25° C.), 40° C. warm water, normal temperature (25° C.) acidic beverage (pH: 5.0-7.0) and normal temperature (25° C.) alkaline beverage (pH: 7.0-9.0). The results listed herein were achieved.

The characteristics of the biodegradable drinking straw 200 are as follows: the drinking straw 200 can be soaked in normal temperature water (25° C.) for 1-1.5 hours without breaking. The drinking straw 200 can be soaked in warm water at 40° C. for 0.5-1 hours without breaking. The drinking straw 200 can be soaked in acidic drinks(pH: 5.0-7.0) at normal temperature (25° C.) for 0.5-1 hours without breaking. The drinking straw 200 can be soaked in alkaline drinks (pH: 7.0-9.0) at normal temperature (25° C.) for 0.5-1 hours without breaking. In all cases listed above, the drinking straw 200 still functions as a drinking straw.

What has been described is a new and improved system for a safe, convenient, hygienic, biodegradable, environmental safe, low-cost drinking straw, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A method for making a low cost biodegradable drinking straw, the method comprising the steps of:
a. providing structurally non-altered corn starch;
b. mixing the structurally non-altered corn starch with one or more than one improver to make a biodegradable powder;
c. extruding the edible biodegradable powder into a drinking straw shape;
d. cooling the drinking straw shaped extrusion;
e. cutting the cooled drinking straw shaped extrusion to an appropriate drinking straw length;
f. drying the cut drinking straws; and
g. packaging the dried drinking straws.

2. The method of claim 1, wherein the structurally non-altered corn starch comprises 90-98% of the drinking straw.

3. The method of claim 1, wherein the structurally non-altered corn starch comprises 98% of the drinking straw.

4. The method of claim 1, wherein 2%-8% of the drinking straw comprises one or more than one starch improver, wherein the one or more than one starch improver comprises a biological enzyme component and an edible colloid component.

5. The method of claim 4, wherein the one or more than one biological enzyme component comprises a combination of 1%-5% of a-amylase, 1%-5% of glucose oxidase, 1%-5% of protease, and 1%-5% of xylanase.

6. The method of claim 5, wherein the one or more than one biological enzyme component comprises 2% of a-amylase, 3% of glucose oxidase and 3% of protease.

7. The method of claim 4, wherein the one or more than one colloid component comprises one or more than one of konjac gum, agar, carrageenan, sodium alginate, guar gum, gellan gum, and xanthan gum.

8. The method of claim 7, wherein the one or more than one colloid component comprises one or more than one of 1%-35% konjac gum, 1%-35% agar, 1%-35% carrageenan, 1%-35% sodium alginate, 1%-35% guar gum, 1%-35% gellan gum, and 1%-45% xanthan gum.

9. The method of claim 8, wherein the one or more than one colloid component comprises 21% of konjac gum, 29% of sodium alginate, 32% of xanthan gum and 10% of gellan gum.

10. A low cost biodegradable edible drinking straw comprising:
a. structurally non-altered corn starch; and
b. one or more than one starch improver, wherein the improver comprises a biological enzyme preparations and an edible colloid preparations.

11. The biodegradable edible drinking straw of claim 10, wherein the biodegradable edible drinking straw comprises 90% -98% corn starch and 2%-8% starch improver.

12. The biodegradable edible drinking straw of claim 10, wherein the biodegradable edible drinking straw comprises 98% corn starch and 2% starch improver.

13. The biodegradable edible drinking straw of claim 11, wherein the one or more than one biological enzyme preparations comprises one or more than one of a -amylase, glucose oxidase, protease, xylanase, konjac gum, sodium alginate, xanthan gum and gellan gum.

14. The biodegradable edible drinking straw of claim 13, wherein the one or more than one biological enzyme preparations comprises 2% a- amylase, 3% of glucose oxidase and 3% of protease.

15. The biodegradable edible drinking straw of claim 11, wherein the one or more than one edible colloid preparations comprises one or more than one of konjac gum, agar, carrageenan, sodium alginate, guar gum, gellan gum, and xanthan gum.

16. The biodegradable edible drinking straw of claim 15, wherein the one or more than one edible colloid preparations comprises 25% of konjac gum, 25% sodium alginate, 35% xanthan gum, and 15% gellan gum.

17. The biodegradable edible drinking straw of claim 10, wherein the biological enzyme preparations are food grade enzyme preparations.

18. The biodegradable edible drinking straw of claim 10, wherein the edible colloid preparations are high integrity food grade colloids.
